(19) United States
(12) Patent Application Publication
(10) Pub. No.: US 2004/0118352 A1
(43) Pub. Date: Jun. 24, 2004

(54) Featherdome bird feeder

(76) Inventors: Charles Lester Adams, Nashville, TN (US); Gary Richard Cummings, Nashville, TN (US); Nancy Daniel Adams, Nashville, TN (US); Sonja Overby Cummings, Nashville, TN (US)

Correspondence Address: Gary R. Cummings, 212 Antioch Pike, Nashville, TN, 37211, US

(21) Appl. No.: 10/328,384

(22) Filed: Dec. 24, 2002

(51) Int. Cl. A01K 61/02

(52) U.S. Cl. 119/57.9

(57) ABSTRACT

The uniqueness of our FEATHERDOME concept brings several features to the market that have been absent in the past, to wit:

(a) The parabolic shell is transparent, weather-proof, steep sided, and very slippery.

(b) When correctly located it is virtually impossible for squirrels, or other animals, to reach the vertical flight entry/exit openings in the Restrictor Plates,

(c) With vertical sides extended several inches below the Restrictor Plates, this prevents a broad jump approach to the openings and does not contain anything to grasp.

(d) The Feed Bin with Perch Ledge is a dry restaurant for birds only, is easy to refill, and contains a Feed Separation Tube to isolate the Anchor Rod assembly.

(e) Restrictor Plates, with multiple diameter openings, give the owner options to choose the size of birds he/she wishes to enter.

### CROSS REFERENCE TO RELATED APPLICATIONS

A Trademark Application for the title “FEATHERDOME” is being submitted concurrently.

### STATEMENT REGARDING FEDERAL SPONSORED RESEARCH AND DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND

Many years of our lives have been enhanced by the joy and entertainment of watching birds feed at the feeders we have provided. Unfortunately, annoying squirrels often invade the feeders, scare away the birds and help themselves to the seeds.

Since there appears to be no feeders on the market that are really squirrel resistant without injuring the squirrels, we decided to design one that would be simple, inexpensive, with easy maintenance and easy installation.

We began watching the activities of birds more closely for help in designing a feeder that would be very difficult for squirrels to enter. Nature solves many problems for us. In the spring season we observed two birds building a nest together. They had found a small hole in the soffit overhang of the house. Interestingly, with ease, they could fly vertically through the hole and land in the attic. Also, they could hover around the hole and use their beaks and claws to pull themselves up through the hole.

This was the information we needed to begin our design!

### BRIEF SUMMARY OF THE INVENTION

Providing a vertical entry from beneath the bird feeder gives our design a unique quality. A clear smooth plastic dome with a parabolic shape is the top (protective) piece to our bird feeder. It provides absolute security against squirrels trying to gain access to the feed by coming down from an overhead approach. They will simply slide off the dome.

Vertical entry through the bottom of our device means squirrels are restricted to the same entry method. Installing the feeder above the ground and out of jumping range for squirrels gives complete privacy use for birds only.

Each unit will include Restrictor Plates with four holes of varying diameters for the discretionary use of the owner. A Restrictor Plate with three inch holes will allow large birds such as Blue Jays and Cardinals to enter, a Restrictor Plate with two inch holes will accommodate medium size birds and a Restrictor Plate with one and one half inch holes will permit only small birds to enter. Several birds can make vertical flight through the access holes at one time and actually feed inside underneath the plastic dome where they are secure from weather.

The dome design shows the bottom of the dome to be a minimum of two inches below the bottom of the Restrictor Plate. This protective shield will be a guard against squirrels attempting a broad (or horizontal) jump at the device to grab on to an edge and gain entry. Squirrels are very good at broad jump but vertical jumping is not within their capability. Our shield will reduce their choice to a vertical jump. We feel this device is as squirrel resistant as possible.

### BRIEF DESCRIPTION OF THE DRAWINGS

FIG. 1 shows a side view of the Parabolic shape of the FEATHERDOME Bird Feeder. An Anchor Rod extends through the Dome with a hanging swivel mounted on top of the rod. The Feed Bin is a separate piece that slides up the Anchor Rod and into the dome. A clear plastic wing nut is used on the bottom of the Anchor Rod, securing the Feed Bin/Restrictor Plate at a position approximately two inches above the bottom edge of the dome.

FIG. 2 is a plan view of the Feed Bin. The bottom of the Feed Bin is a Restrictor Plate that is part of the Feed Bin and its outside diameter makes contact with the inside of the FEATHERDOME at the bottom of the stop/stabilization ledge creating a snug fit.

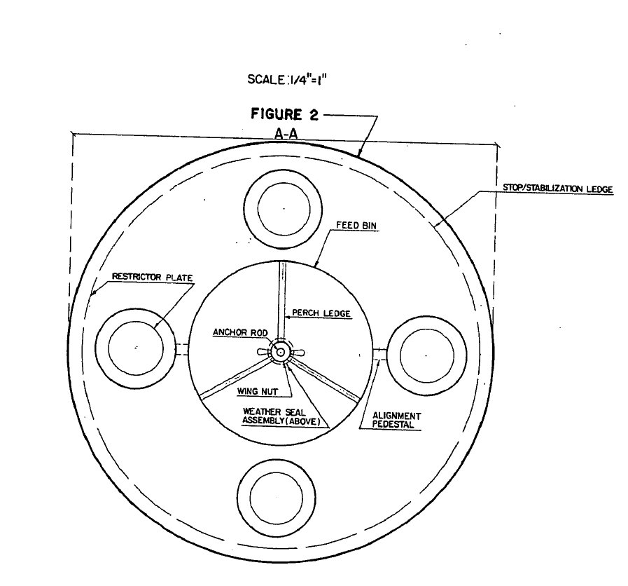

### DETAILED DESCRIPTION OF THE INVENTION

The FEATHERDOME has six parts as named below.

1. Parabolic Dome

2. Feed Bin

3. Anchor Rod

4. Hanging Swivel mounted on top of Anchor Rod

5. Wing Nut mounted on bottom of Anchor Rod

6. Restrictor Plates

All parts shall be manufactured of clear plastic of moderate strength since only moderate forces will be acting on the whole unit. Anchor Rod will be threaded on both ends to receive the hanging swivel at top and wing nut at bottom.

Separate Restrictor Plates will also be manufactured of clear plastic. Plates will be donut shaped plates that slip over and down beside the Feed Bin. Four holes will be placed in the ring of the Restrictor Plates to reduce the size of the holes already existing in the monolithic unit of the Feed Bin and Restrictor Plate containing the largest size entry/exit holes. Purpose of the Restrictor Plates is to give individuals the option of restricting the use of the FEATHERDOME to smaller birds. If larger birds become a nuisance, they can be excluded by use of a Restrictor Plate with smaller holes. (If squirrels are presenting a pesky annoyance, an owner may install a plate with smaller holes to block them out. We have determined that a full grown squirrel can pass through a two inch hole. A one and one-half inch hole will restrict the squirrel.)

With all the plastic manufactured parts in hand the assembly of the transparent parts would be as follows:

1. Fill the Feed Bin with approximately four inches of bird seed.

2. Insert the Anchor Rod through the underside side of the Dome and out the top hole. Place swivel on top securely.

3. Select the desired size Restrictor Plate and place over the Feed Bin. Rotate plate until it is secure and flat against the lower Feed Bin plate.

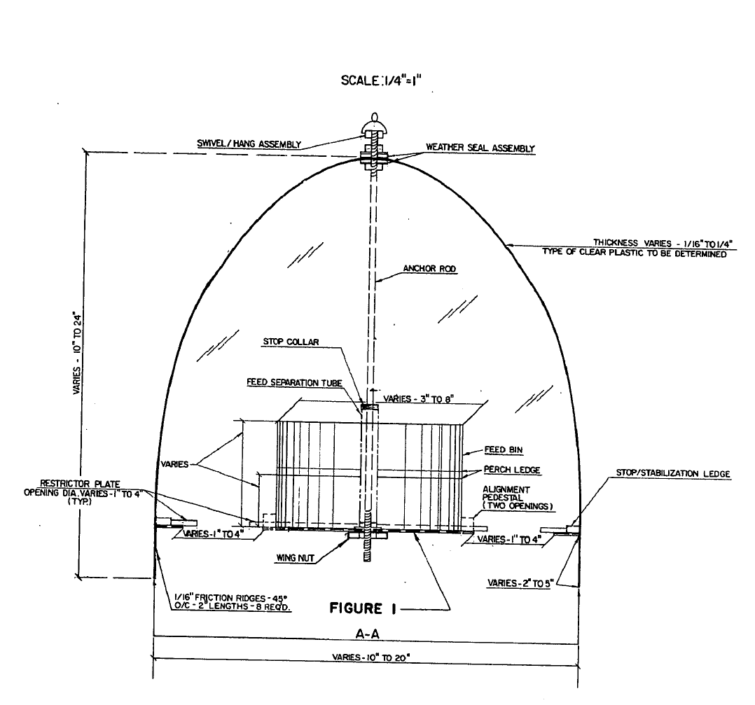

4. While holding the Dome and Anchor Rod, slide the Feed Bin onto the Anchor Rod up to the stop collar (see FIG. 1). While holding the FEATHERDOME with one hand, complete the assembly by installing the Wing Nut to a secure position with the other hand.

The FEATHERDOME may by installed at any desired location around your property. As the inventors we have now provided any individual with a device that has strong defenses against intrusion by squirrels. The final squirrel proofing rests with the installer. A careful well thought out installation plan is required to outsmart those pesky squirrels.

1. We claim that the vertical entry design of our FEATHERDOME is a unique and innovative approach in selectively feeding birds while limiting access by squirrels and other animals and that no other bird feeder on the market utilizes this method for entry/exit to their feeders. Restrictor Plates are a new idea for use in bird feeders. Our research has revealed no other devices offering the use of Restrictor Plates. As previously stated, we have observed birds flying horizontally, abruptly changing to vertical flight and flying through a small hole. We know the birds can handle the entry to our FEATHERDOME.
